(19) United States
(12) Patent Application Publication
(10) Pub. No.: US 2016/0139324 A1
(43) Pub. Date: May 19, 2016

(54) LAMINATE, METHOD FOR PRODUCING LAMINATE, LIGHT GUIDE BODY FOR LIGHT SOURCE DEVICES, AND LIGHT SOURCE DEVICE

(71) Applicant: MITSUBISHI RAYON CO., LTD., Tokyo (JP)

(72) Inventors: Kenji YAGI, Yokohama-shi (JP); Tomonari YOSHIMURA, Yokohama-shi (JP); Kouichi TAKENAKA, Tokyo (JP); Tetsuya NISHIMOTO, Yokohama-shi (JP)

(73) Assignee: Mitsubishi Rayon Co., Ltd., Chiyoda-ku, TK (JP)

(21) Appl. No.: 14/893,548

(22) PCT Filed: Jun. 16, 2014
(86) PCT No.: PCT/JP2014/065883

§ 371 Date: Nov. 24, 2015

(30) Foreign Application Priority Data
Jun. 18, 2013 (JP) 2013-127273
Aug. 7, 2013 (JP) 2013-163827

(51) Int. Cl. F21V 8/00

(52) U.S. Cl. CPC G02B 6/0065; G02B 6/0055; G02B 6/0045; G02B 6/0051

(57) ABSTRACT

A laminate which comprises a core layer, a first cladding layer, a second cladding layer and a light reflecting layer, and wherein the light reflecting layer, the second cladding layer, the core layer and the first cladding layer are sequentially laminated. The refractive index of the first cladding layer and the refractive index of the second cladding layer are lower than the refractive index of the core layer, and the light reflecting layer has a thickness of 50 μm or more.

### TECHNICAL FIELD

The present invention relates to a laminate, a method for producing a laminate, a light guide body for light source device, and a light source device.

The present application contains subject matter related to Japanese Patent Application Nos. 2013-127273 and 2013-163827 filed in the Japanese Patent Office on Jun. 18 and Aug. 7, 2013, respectively, the entire contents of which are incorporated herein by reference.

### BACKGROUND ART

In the related art, as a light source device used for a liquid crystal display device used for a mobile phone, a notebook PC, an LCD TV, a video camera, or the like, a display device such as backlight keys of a mobile phone, a backlight keyboard of a PC, or display switch of an electronic apparatus or a car, or an illumination device of indoor lighting such as a ceiling light, an illumination signboard, or the like, for example, there are a direct-under type light source device where a line-shaped light source such as a fluorescent lamp is arranged or a plurality of point light sources such as light emitting diodes are arranged in a housing, an edge-light type light source device where a line-shape light source is arranged or point light sources are arranged on a side surface of a plate-shaped light guide body, and the like.

Typically, the edge-light type light source device includes a transparent light guide body of an acrylic resin plate having a rectangular plate shape and a light source. The light source is arranged to face the side surface of the light guide body. In the light source device, light from the light source is incident from a side surface (light incidence surface) on the light guide body, and light is emitted from an emitting mechanism formed on a first surface (sometimes, referred to as a light emitting surface) or a second surface (sometimes, referred to as a rear surface) which is a surface facing the first surface of the light guide body or is emitted from a light emitting surface by a light emitting element of light diffusion particles or the like contained in the light guide body.

In such a light guide body, since the light incident from the side surface is emitted from the rear surface of the light guide body as well as from the light emitting surface, the amount of light emitted from the light emitting surface is decreased. Therefore, in the light source device, a light reflecting layer is installed on the second surface of the light guide body, that is, the surface facing the light emitting surface of the light guide body to reflect the light emitted from the second surface, and thus, the light is emitted from the light emitting surface or returned into the light guide body, so that the light emitted from the second surface is reused. In this manner, by using the light from the light source with high efficiency, it is possible to obtain a light source device having excellent luminance.

Patent Document 1 discloses a light guide body for light source device having excellent luminance by installing a light reflecting layer scattering and reflecting light on a front surface of the light guide body having a core clad structure and incorporating a function of the light reflecting layer into the light guide body.

### CITATION LIST

### Patent Document

Patent Document 1: WO 2010/073726 A

### SUMMARY OF THE INVENTION

### Problem to be Solved by the Invention

In a case where a light reflecting layer scattering and reflecting light is installed on the front surface of a light guide body configured with a core clad structure, brightness, that is, luminance of the light guide body greatly depends on a reflectance of the light reflecting layer.

In a light guide body for light source device disclosed in Patent Document 1, since the light reflecting layer is formed by printing, irregularity occurs in thickness of the light reflecting layer, so that variation in reflectance easily occurs. Therefore, irregularity easily occurs in luminance of the light guide body.

In addition, in the formation of the light reflecting layer by printing, it is difficult to obtain high reflectance by one-time printing process. In order to obtain high reflectance, the printing process needs to be performed several times to increase the thickness of the light reflecting layer. As a result, the processes become complicated, and the production cost is increased. Furthermore, in a case where the light guide body is bent, the light reflecting layer formed by printing is easily peeled off, and thus, the durability of the light reflecting layer is not sufficient.

An object of the invention is to provide a laminate having a light reflecting layer of which reflectance is easily adjusted and which has excellent durability.

In addition, another object of the invention is to provide a method for producing a laminate having a light reflecting layer of which reflectance is easily adjusted and which has excellent durability simply at suppressed production cost.

In addition, still another object of the invention is to provide a light source device having excellent luminance including a laminate which has a light reflecting layer of which reflectance is easily adjusted and which has excellent durability.

### Means for Solving Problem

The above objects are achieved by the invention disclosed in (1) to (13) as follows.

(1) A laminate including a core layer, a first cladding layer, a second cladding layer, and a light reflecting layer, wherein the light reflecting layer, the second cladding layer, the core layer, and the first cladding layer are sequentially laminated, wherein a refractive index of the first cladding layer and a refractive index of the second cladding layer are lower than a refractive index of the core layer, and wherein a thickness of the light reflecting layer is 50 μm or more.

(2) The laminate according to (1), further including a light emitting element.

(3) The laminate according to (1) or (2), further including an adhesive layer between the light reflecting layer and the second cladding layer.

(4) The laminate according to any one of (1) to (3), wherein the light reflecting layer is made of a material which scatters and reflects light.

(5) The laminate according to any one of (1) to (4), wherein a material of the light reflecting layer is a material of at least one type selected from a group including a polyolefin resin, a polyester resin, an acrylic resin, and cellulose.

(6) The laminate according to any one of (1) to (5), wherein a reflectance of the light reflecting layer is 70% or more.

(7) The laminate according to any one of (1) to (5), wherein a reflectance of the light reflecting layer is 65% or less.

(8) The laminate according to (7), wherein in the light reflecting layer, a layer of at least one type selected from a group including a design layer and a light diffusion layer is further laminated on a surface facing an interface between the light reflecting layer and the second cladding layer.

(9) A method for producing a laminate, including laminating a first cladding layer on a first surface of a core layer, laminating a second cladding layer on a second surface of the core layer, and laminating a light reflecting layer on a second surface of the second cladding layer, wherein a refractive index of the first cladding layer and a refractive index of the second cladding layer are lower than a refractive index of the core layer, wherein a thickness of the light reflecting layer is 50 μm or more, and wherein laminating of the light reflecting layer is performed by lamination.

(10) A light guide body for light source device including the laminate according to any one of (1) to (8).

(11) A light source device including the laminate according to any one of (1) to (8) and a light source.

(12) A single-sided light-emitting light source device including the laminate according to claim (6) and a light source.

(13) A double-sided light-emitting light source device including the laminate according to claim (7) or (8) and a light source.

### Effect of the Invention

In a laminate according to the invention, reflectance of a light reflecting layer is easily adjusted and durability of the laminate is excellent. In addition, by using the laminate according to the invention, it is possible to obtain a light source device having excellent luminance.

According to a method for producing a laminate according to the invention, it is possible to form a laminate having a light reflecting layer of which reflectance is easily adjusted and which has excellent durability simply at suppressed production cost. In addition, by using the obtained laminate, it is possible to obtain a light source device having excellent luminance.

Since the light source device according to the invention includes a laminate having a light reflecting layer of which reflectance is easily adjusted and which has excellent durability, the light source device has excellent luminance.

### BRIEF DESCRIPTION OF DRAWINGS

FIG. 1 is a schematic perspective diagram illustrating an embodiment of a laminate according to the invention;

FIG. 2 is a schematic perspective diagram illustrating another embodiment of a laminate according to the invention;

FIG. 3 is a schematic cross-sectional diagram illustrating a form of a laminate where a light reflecting layer is not installed;

FIG. 4 is a schematic cross-sectional diagram illustrating an embodiment of a laminate according to the invention;

FIG. 5 is a schematic cross-sectional diagram illustrating another embodiment of a laminate according to the invention;

FIG. 6 is a schematic cross-sectional diagram illustrating another embodiment of a laminate according to the invention;

FIG. 7 is a schematic cross-sectional diagram illustrating an embodiment of a light source device using a laminate according to the invention;

FIG. 8 is a schematic cross-sectional diagram illustrating a measurement apparatus measuring an average normal-line luminance of a light source device;

FIG. 9 is a schematic cross-sectional diagram illustrating a measurement apparatus measuring a luminance distribution of a light source device;

FIG. 10 is a diagram illustrating a luminance distribution of a light source device obtained in Example 1;

FIG. 11 is a diagram illustrating a luminance distribution of a light source device obtained in Example 2; and

FIG. 12 is a diagram illustrating a luminance distribution of a light source device obtained in Example 3.

### MODE(S) FOR CARRYING OUT THE INVENTION

Hereinafter, embodiments of the invention will be described with reference to the drawings, but the invention is not limited to the embodiments and the drawings. Hereinafter, in a core layer 11, an interface between the core layer 11 and a first cladding layer 121 is referred to as a first surface of the core layer 11, and an interface between the core layer 11 and a second cladding layer 122 is referred to as a second surface of the core layer 11. In addition, in the first cladding layer 121, a surface facing the interface between the first cladding layer 121 and the core layer 11 is referred to as a first surface of the first cladding layer 121, and an interface between the first cladding layer 121 and the core layer 11 is referred to as a second surface of the first cladding layer 121. In the second cladding layer, an interface between the second cladding layer 122 and the core layer 11 is referred to as a first surface of the second cladding layer 122, and a surface facing the interface between the second cladding layer 122 and the core layer 11 is referred to as a second surface of the second cladding layer 122.

(Laminate 10)

A laminate 10 (hereinafter, simply a laminate 10 according to the invention) as a form of the invention is a laminate including a core layer 11, a first cladding layer 121, a second cladding layer 122, and a light reflecting layer 14. In addition, the light reflecting layer 14, the second cladding layer 122, the core layer 11, and the first cladding layer 121 are sequentially laminated from the lower side in this order described, and a refractive index of the first cladding layer 121 and a refractive index of the second cladding layer 122 are lower than a refractive index of the core layer 11. In addition, the laminate further includes an adhesive layer 13 between the second cladding layer 122 and the light reflecting layer 14.

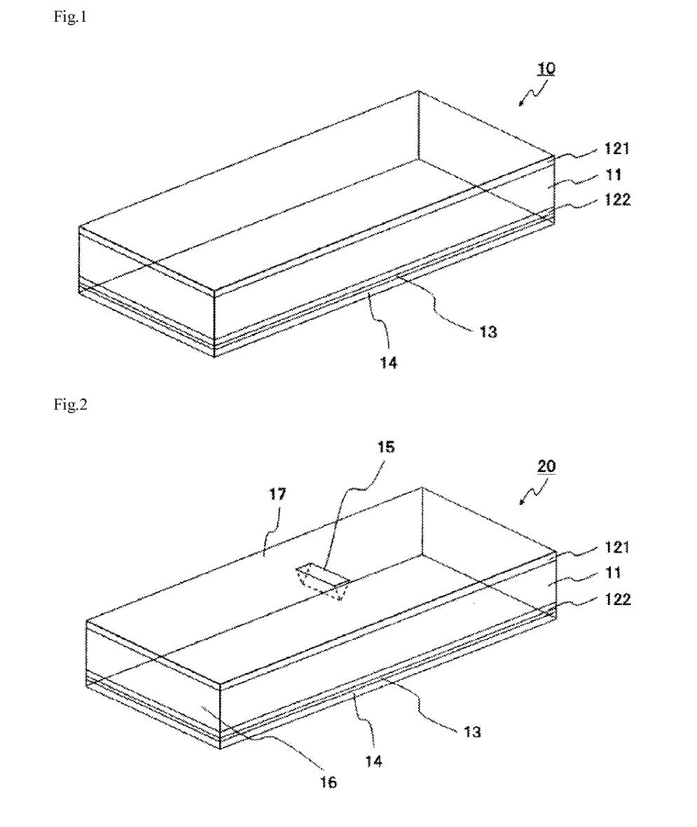

FIG. 1 is a schematic perspective diagram illustrating an embodiment of the laminate 10 according to the invention. The laminate 10 illustrated in FIG. 1 includes the core layer 11, the first cladding layer 121, the second cladding layer 122, and the light reflecting layer 14. The laminate further includes an adhesive layer 13 between the second cladding layer 122 and the light reflecting layer 14.

The shape of the laminate 10 is a plate shape, which is not particularly limited. The configuration that the shape of the laminate 10 is a plate shape denotes that a thickness T of the laminate 10 is small and an area of the first surface of the first cladding layer 121 is large.

More specifically, the thickness T of the laminate 10 is preferably in a range of 0.03 to 12 mm, more preferably in a range of 0.2 to 5.5 mm, and the area of the first surface of the first cladding layer 121 is preferably in a range of 200 to 500000 mm², more preferably in a range of 500 to 250000 mm². The thickness T of the laminate 10 is a distance between the second surface of the second cladding layer 122 and the first surface of the first cladding layer 121. The thickness T of the laminate 10 is calculated by cutting the laminate 10 in a vertical direction to obtain a cross section, photographing the cross section with a microscope, measuring the shortest distance from an arbitrary point of the second surface of the second cladding layer 122 to the first surface of the first cladding layer 121 at arbitrary five positions (however, in the portion where the light emitting element 15 is not installed), and obtaining an average value thereof. In addition, as a shape of the laminate 10, for example, a polygonal shape such as a rectangle or a triangle or a circular shape such as a true circle or an ellipse is exemplified in a case where the laminate is seen from the normal direction of the first surface of the first cladding layer 121. Among these shapes, in a case where the laminate 10 is used as the light source device 60, workability is excellent, and light from the light source 31 is easily incident. Therefore, as the shape of the laminate 10, the polygonal shape is preferred, and the rectangular shape is more preferred.

The laminate 10 may also have a shape where the entire portion thereof is curved or bent.

(Core Layer 11)

The core layer 11 is configured with a highly transparent material, which is not particularly limited, and the material can be appropriately selected according to the purpose of use or the like.

The phrase “highly transparent” denotes that a value of transmittance measured in accordance with ISO 13468 is in a range of 50 to 100%.

As of the core layers 11, for example, an acrylic resin, a polycarbonate resin, an acrylic polyolefin resin, a glass and the like can be exemplified. Among these materials of the core layer 11, due to a light weight and an excellent handling property, the acrylic resin, the polycarbonate resin, and the acrylic polyolefin resin are preferred.

The acrylic resin is preferred due to excellent transparency, excellent durability, and inexpensiveness.

As the acrylic resin, for example, a methyl methacrylate homopolymer, a copolymer of methyl methacrylate and other monomers, and the like can be exemplified. Among these acrylic resins, due to more excellent transparency, excellent durability, and more inexpensiveness, the methyl methacrylate homopolymer and a copolymer containing methyl methacrylate units of 50 mass % or more and less than 100 mass % over a total mass of the copolymer are preferred.

In the case of using the copolymer of methyl methacrylate and other monomers, the content of the methyl methacrylate units in the copolymer is preferably 50 mass % or more and less than 100 mass % over the total mass of the copolymer, more preferably 60 mass % or more and less than 100 mass %, still more preferably 70 mass % or more and less than 100 mass %.

As other monomers, for example, (meth) acrylates such as methyl acrylate, ethyl (meth) acrylate, n-propyl (meth) acrylate, n-butyl (meth) acrylate, n-hexyl (meth) acrylate, and cyclohexyl (meth) acrylate; a (meth) acrylic acid; a maleic anhydride; maleimides; aromatic vinyls such as styrene can be exemplified.

In addition, in this specification, the (meth) acrylate denotes an acrylate or a methacrylate.

The polycarbonate resin and the acrylic polyolefin resin are preferred due to excellent heat resistance and excellent incombustibility. In particular, since the refractive index of the polycarbonate resin is high and a numerical aperture thereof can be increased, although the laminate 10 is bent, light leakage can be suppressed to be small, so that the polycarbonate resin is preferred.

In addition, the numerical aperture is an indicator of collection of light. As the numerical aperture is increased, the amount of received light can be increased. Therefore, although the laminate 10 is bent, the light leakage can be suppressed to be small.

Due to easiness of formation of the laminate 10 and capability of thinning the light source device 60, the thickness of the core layer 11 is preferably in a range of 0.01 to 10 mm, more preferably in a range of 0.05 to 5 mm. The thickness of the core layer 11 is a distance between the second surface and the first surface of the core layer 11. The thickness of the core layer 11 is calculated by cutting the core layer 11 in a vertical direction thereof to obtain a cross section, photographing the cross section with a microscope, measuring the shortest distance from an arbitrary point of the second surface of the core layer 11 to the first surface of the core layer 11 at arbitrary five positions (however, in the portion where the light emitting element 15 is not installed), and obtaining an average value thereof.

(First Cladding Layer 121, Second Cladding Layer 122)

The first cladding layer 121 and the second cladding layer 122 is configured with a highly transparent material having a refractive index lower than the refractive index of the core layer 11, which is not particularly limited, and the material can be appropriately selected according to the purpose of use or the like.

As the material of the first cladding layer 121 and the second cladding layer 122, a material having a refractive index lower than the refractive index of the core layer 11 can be appropriately selected.

In the case of using the acrylic resin as the material of the core layer 11, as the material of the first cladding layer 121 and the second cladding layer 122, for example, a fluorine-containing olefin resin or the like can be exemplified.

As the fluorine-containing olefin resin, for example, a vinylidene fluoride homopolymer, a copolymer of vinylidene fluoride and tetrafluoroethylene, a copolymer of vinylidene fluoride and hexafluoropropylene, a copolymer of vinylidene fluoride and trifluoroethylene, a copolymer of vinylidene fluoride, tetrafluoroethylene, and hexafluoropropylene, and the like can be exemplified. Among these fluorine-containing olefin resins, due to excellent processability or moldability, the vinylidene fluoride homopolymer is preferred.

In the case of using the polycarbonate resin as the material of the core layer 11, as the material of the first cladding layer 121 and the second cladding layer 122, for example, a fluorine-containing olefin resin, an acrylic resin, and the like can be exemplified.

Specific examples of the fluorine-containing olefin resin and the acrylic resin are same as described above, and the preferable ranges and the reasons are also same as described above.

A difference in refractive index between the refractive index n₁ of the core layer 11 and the refractive index n₂ of the first cladding layer 121 and/or the second cladding layer 122 is preferably 0.001 or more, more preferably 0.01 or more. If the difference in refractive index between the refractive index n₁ of the core layer 11 and the refractive index n₂ of the first cladding layer 121 and/or the second cladding layer 122 is 0.001 or more, light incident from a light incidence surface can propagate to a faraway site with little loss while totally reflecting on the interface between the core layer 11 and the first cladding layer 121 and the interface between the core layer 11 and the second cladding layer 122, and even though other layers are installed on front surfaces of the first cladding layer 121 and/or the second cladding layer 122, light leakage becomes small.

In addition, the difference in refractive index between the refractive index n₁ of the core layer 11 and the refractive index n₂ of the first cladding layer 121 and/or the second cladding layer 122 is defined as a value obtained by subtracting the refractive index n₂ of the first cladding layer 121 and/or the second cladding layer 122 from the refractive index n₁ of the core layer 11.

The refractive index is defined as a value obtained by measurement using sodium D line at 23° C. with an Abbe refractometer in accordance with ISO 13468.

Due to excellent handling property and capability of obtaining the laminate 10 having excellent light confinement efficiency, the thickness of the cladding layer 12 is preferably in a range of 1 to 500 μm, more preferably in a range of 3 to 100 μm.

The thickness of the first cladding layer 121 is calculated by cutting the first cladding layer 121 in a vertical direction thereof to obtain a cross section, photographing the cross section with a microscope, measuring the shortest distance from an arbitrary point of the second surface of the first cladding layer 121 to the first surface of the first cladding layer 121 at arbitrary five positions (however, in the portion where the light emitting element 15 is not installed), and obtaining an average value thereof. The thickness of the second cladding layer 122 is calculated by cutting the second cladding layer 122 in a vertical direction thereof to obtain a cross section, photographing the cross section with a microscope, measuring the shortest distance from an arbitrary point of the second surface of the second cladding layer 122 to the first surface of the second cladding layer 122 at arbitrary five positions (however, in the portion where the light emitting element 15 is not installed), and obtaining an average value thereof.

A ratio between the thickness of the core layer 11 and the thickness of the first cladding layer 121 and a ratio between the thickness of the core layer 11 and the thickness of the second cladding layer 122 can be appropriately selected according to the material of the core layer 11 and the material of the first cladding layer 121 and the second cladding layer 122.

A ratio between the volume of the core layer 11 and the volume of the first cladding layer 121 and a ratio between the volume of the core layer 11 and the volume of the second cladding layer 122 can be appropriately selected according to the material of the core layer 11 and the material of the first cladding layer 121 and the second cladding layer 122.

The materials, thicknesses, and volumes of the first cladding layer 121 installed on the front surface of the core layer 11 and the second cladding layer 122 installed on the rear surface of the core may be equal to each other or may be different from each other.

The side surface of the core layer 11 may be covered with the first cladding layer 121 and/or the second cladding layer 122 or may not be covered.

(Adhesive Layer 13)

The adhesive layer 13 has a function of adhering the light reflecting layer 14 to the first cladding layer 121 and the second cladding layer 122.

The adhesive layer 13 is made of a material which is a highly transparent material and a material having excellent adhesion of the light reflecting layer 14 to the first cladding layer 121 and second cladding layer 122, which is not particularly limited, and the material can be appropriately selected according to the purpose of use or the like.

As the material of the adhesive layer 13, for example, an acrylic resin adhesive agent, a natural rubber-based adhesive agent, a synthetic rubber-based adhesive agent, a silicon-based adhesive agent, a urethane-based resin adhesive agent, an epoxy-based resin adhesive agent, and the like can be exemplified. One type of these adhesive agents 13 may be solely used, and two or more types may be used in combination or mixed. Among these adhesive agents 13, due to excellent adhesion, the acrylic resin adhesive agent, the natural rubber-based adhesive agent, the synthetic rubber-based adhesive agent, the silicon-based adhesive agent, the urethane-based resin adhesive agent, and the epoxy-based resin adhesive agent are preferred, the acrylic resin adhesive agent, the natural rubber-based adhesive agent, and the synthetic rubber-based adhesive agent are more preferred, and the acrylic resin adhesive agent is still more preferred.

Although the laminate 10 is bent, the deformation is small, the handling property of the laminate 10 is excellent, and the strength of adhesion of the light reflecting layer 14 to the first cladding layer 121 and the second cladding layer 122 is excellent. Therefore, the thickness of the adhesive layer 13 is preferably in a range of 1 to 500 μm, more preferably in a range of 3 to 100 μm.

The thickness of the adhesive layer 13 is calculated by cutting the adhesive layer 13 in a vertical direction thereof to obtain a cross section, photographing the cross section with a microscope, measuring the shortest distance from an arbitrary point of the surface of the adhesive layer 13 facing an interface between the adhesive layer 13 and the first cladding layer 121 or the second cladding layer 122 to the interface between the adhesive layer 13 and the first cladding layer 121 or the second cladding layer 122 at arbitrary five positions (however, in the portion where the light emitting element 15 is not installed), and obtaining an average value thereof.

In order to improve adhesion of the first cladding layer 121 and the second cladding layer 122 to the adhesive layer 13 and adhesion of the light reflecting layer 14 to the adhesive layer 13, a process such as corona discharging or plasma discharging may be applied on the surfaces of the first cladding layer 121 and the second cladding layer 122 or the light reflecting layer 14 being adhered to the adhesive layer 13 to reform the surfaces.

(Light Reflecting Layer 14)

The light reflecting layer 14 is a layer capable of scattering and reflecting light, which is not particularly limited, and the material can be appropriately selected according to the purpose of use or the like.

As the material of the light reflecting layer 14, for example, a resin plate or a resin film of a polyolefin resin, a polyester resin, an acrylic resin, or the like, paper of cellulose or the like, and the like can be exemplified. Among the materials of the light reflecting layer 14, due to little peeling of the light reflecting layer 14 even in a case where the laminate 10 is bent, excellent durability of the laminate 10, and functioning as a protective film of the laminate 10, the polyolefin resin, the polyester resin, the acrylic resin, and the cellulose are preferred, and the polyester resin is more preferred.

The light reflecting layer 14 may be formed by foaming or may include a pigment or diffusion particles.

As the pigment, for example, a white pigment of titanium oxide, barium sulfate, calcium carbonate, magnesium carbonate, or the like can be exemplified. One type of these pigments may be solely used, and two or more types may be used in combination or mixed. Among these pigments, due to highness of the reflectance over the entire range of visible light, the white pigment is preferred.

With respect to the reflectance of the light reflecting layer 14, due to large influence on the luminance of the light source device, preferably, the material or the like is appropriately selected according to optical characteristics of interest.

In a case where only one surface of the light source device 60 is allowed to emit light, due to excellent luminance of the light source device 60, the reflectance of the light reflecting layer 14 is preferably 70% or more, more preferably in a range of 70 to 100%, still more preferably in a range of 75 to 100%.

In a case where both surfaces of the light source device 60 are allowed to emit light, due to easiness in balancing the luminance between the both surfaces of the light source device 60, the reflectance of the light reflecting layer 14 is preferably 65% or less, more preferably in a range of 25 to 65%, still more preferably in a range of 30 to 60% or less.

In this specification, the reflectance is calculated by illuminating the surface where the light reflecting layer 14 of the laminate 10 is not formed or the surface where the adhesive layer 13 is formed with light of 560 nm and measuring the reflectance of the light of 560 nm by using a spectrophotometer.

The thickness of the light reflecting layer 14 may be appropriately selected according to the reflectance of the light reflecting layer 14 or the purpose of the laminate 10. Although the laminate 10 is bent, the light reflecting layer 14 is little peeled; the durability of the laminate 10 is excellent; and the light reflecting layer can also function as a protective film of the laminate 10. Therefore, the thickness of the light reflecting layer is preferably in a range of 10 to 500 μm, more preferably in a range of 50 to 200 μm. The thickness of the light reflecting layer 14 is calculated by cutting the light reflecting layer 14 in a vertical direction thereof to obtain a cross section, photographing the cross section with a microscope, measuring the shortest distance from an arbitrary point of the surface of the light reflecting layer 14 facing an interface between the light reflecting layer 14 and the core layer 11 to the interface between the light reflecting layer 14 and the core layer 11 at arbitrary five positions (however, in the portion where the light emitting element 15 is not installed), and obtain in an average value thereof.

The light reflecting layer 14 may be installed on the second surface of the second cladding layer 122 through the adhesive layer 13. In addition, the light reflecting layer 14 may be installed on the first surface of the first cladding layer 121 through the adhesive layer 13.

In a case where only the first surface of the light source device 60 is desired to emit light due to excellent luminance of the light source device 60, the light reflecting layer 14 is preferably installed on only the second surface of the laminate 10.

In a case where both surfaces of the light source device 60 are desired to emit light, the light reflecting layer 14 may be installed on only one surface of the laminate 10 or may be installed on both surfaces of the laminate 10.

Although the light reflecting layer 14 can be appropriately selected according to the purpose of the laminate 10, the light reflecting layer may cover the entire surfaces of the first cladding layer 121 and/or the second cladding layer 122 or may cover partial areas of the first cladding layer 121 and/or the second cladding layer 122.

In a case where the light reflecting layer 14 covers partial areas of the first cladding layer 121 and/or the second cladding layer 122, the adhesive layer 13 may be installed only the area where the light reflecting layer 14 is installed and may be installed to include the area where the light reflecting layer 14 is not installed.

In a case where the light reflecting layer 14 covers partial area of the second cladding layer 122, since light is reflected on the area, preferably, the light emitting element 15 is installed in the area, or the light emitting element 15 is installed in an area facing the area of the first cladding layer.

(Light Emitting Element 15)

FIG. 2 is a schematic perspective diagram illustrating an embodiment of a laminate 20 (hereinafter, simply referred to as a laminate 20 according to the invention) as a form of the invention. As illustrated in FIG. 2, preferably, the laminate 20 according to the invention further includes the light emitting element 15.

The laminate 20 illustrated in FIG. 2 includes a core layer 11, a first cladding layer 121 installed on a first surface of the core layer 11, a second cladding layer 122 installed on a second surface of the core layer 11, a light reflecting layer 14 installed on a second surface of the second cladding layer 122 through an adhesive layer 13, and a light emitting element 15 installed in the first cladding layer 121 to reach from the first surface thereof to an inner portion of the core layer 11.

The light emitting element 15 is an element of allowing the light propagating through the inner portion of the core layer 11 to emit to the outside of the core layer 11, and for example, a concave portion penetrating the first cladding layer 121 and reaching an inner portion of the core layer 11, a concave portion penetrating the second cladding layer 122 and reaching an inner portion of the core layer 11, a concave portion formed not to penetrate the first cladding layer 121 and to reach from the interface between the first cladding layer 121 and the core layer 11 to an inner portion of the core layer 11, a concave portion formed not to penetrate the second cladding layer 122 and to reach from the interface between the second cladding layer 122 and the core layer 11 to an inner portion of the core layer 11, and the like can be exemplified. One type of these light emitting elements 15 may be solely used, and two or more types may be used in combination. Among these light emitting elements 15, due to easiness in controlling light emitting position, the concave portion penetrating the first cladding layer 121 and reaching an inner portion of the core layer 11, and the concave portion penetrating the second cladding layer 122 and reaching an inner portion of the core layer 11 are preferred, and the concave portion penetrating the first cladding layer 121 and reaching an inner portion of the core layer 11 is more preferred.

By reflection or refraction at the concave portion penetrating the first cladding layer 121 and reaching an inner portion of the core layer 11, the light propagating through the inner portion of the core layer 11 is emitted from the core layer 11 to be emitted from the light emitting element 15 of the light emitting surface 17. Otherwise, the light reaches the light reflecting layer 14 and, after scattering and reflection, the light is emitted from the light emitting surface 17. Otherwise, the light passes through the light reflecting layer 14 to be emitted or to be returned to the core layer 11 to be guided to propagate. In addition, as one aspect of the invention, the light emitting surface 17 denotes the first surface of the first cladding layer 121 of the laminate 20.

The functions of the light emitting element 15 and the light reflecting layer 14 will be described.

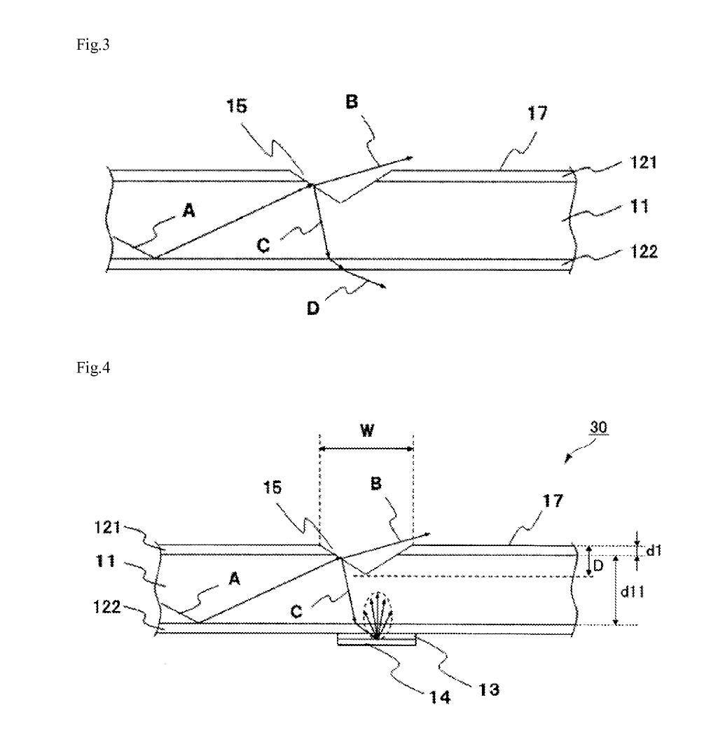

FIG. 3 is a schematic cross-sectional diagram illustrating a form of a laminate where the light reflecting layer 14 is not installed. The laminate illustrated in FIG. 3 includes a core layer 11, a first cladding layer installed on a first surface of the core layer 11, a second cladding layer 122 installed on a second surface of the core layer 11, and a light emitting element 15 installed in the first cladding layer 121 to reach from a first surface thereof to an inner portion of the core layer 11.

FIG. 4 is a schematic cross-sectional diagram illustrating an embodiment of a laminate 30 (hereinafter, simply referred to as a laminate 30 according to the invention) as a form of the invention. The laminate 30 illustrated in FIG. 4 includes a core layer 11, a first cladding layer 121 installed on a first surface of the core layer 11, a second cladding layer 122 installed on a second surface of the core layer 11, a light reflecting layer 14 installed on a surface of the second cladding layer 122 through an adhesive layer 13, and a light emitting element 15 installed in the first cladding layer 121 to reach from the first surface thereof to an inner portion of the core layer 11.

In the laminate illustrated in FIG. 3, a portion of light A that is totally reflected on the interface between core layer 11 and the first cladding layer 121 and the interface between the core layer and the second cladding layer 122 to propagate is refracted at the concave portion, and the refracted light B is emitted from the light emitting surface 17. In addition, a portion of the light A is reflected on the concave portion, and the reflected light C passes through the second cladding layer 122. Since the light reflecting layer 14 is not installed, the light is leaked out.

In the laminate 30 illustrated in FIG. 4, a portion of the light A that is totally reflected on the interface between the core layer 11 and the first cladding layer 121 and the interface between the core layer and the second cladding layer 122 to propagate is refracted at the concave portion, and the refracted light B is emitted from the light emitting surface 17. In addition, a portion of the light A is reflected on the concave portion, and the reflected light C passes through the second cladding layer 122. Since the light is reflected by the light reflecting layer 14, the light is emitted from the light emitting surface or is returned into the core layer 11. Therefore, in the laminate 30 illustrated in FIG. 4, the leakage of light can be prevented.

By performing adjustment such as decreasing or the like of the reflectance of the light reflecting layer 14 on the laminate 30 illustrated in FIG. 4, light emitting can be performed while balancing the luminance between the both surfaces of the laminate 30.

Like the laminate 30 illustrated in FIG. 4, in a case where the light reflecting layer 14 covers a partial area of the second cladding layer 122, the size or position of the adhesive layer 13 or the light reflecting layer 14 can be appropriately selected according to the shape of the light emitting element 15, the material of the core layer 11 or the cladding layer 12, or the like. Namely, by installing the adhesive layer 13 or the light reflecting layer 14 having a necessary size at a necessary position according to a reflecting angle of the light C, the light leakage is decreased, so that light emitting can be achieved with excellent luminance.

The light emitting element 15 may be installed on the light emitting surface 17 or may be further installed on a surface other than the light emitting surface 17.

In a case where only one surface of the light source device 60 is desired to emit light, the light emitting element 15 may be installed on only one surface of the laminate 30 or may be installed on both surfaces of the laminate 30.

In a case where both surfaces of the light source device 60 are desired to emit light, due to easiness in adjusting the luminance of the both surfaces of the light source device 60, preferably, the light emitting element 15 is installed on the both surfaces of the laminate 30.

The shape of the light emitting element 15 may be appropriately selected according to an amount of light, an optical guiding distance, an emission type required in the laminate 30, or the like.

As the shape of the light emitting element 15, a conical shape, a pyramid shape, a spherical segment shape, a prism shape of a triangular prism, a rectangular prism, or the like, a line shape, and the like can be exemplified. One type of these light emitting elements 15 may be solely used, and two or more types may be used in combination.

In the case were the shape of the light emitting element 15 is a conical shape, a pyramid shape, or a spherical segment shape, the bottom surface having a conical shape, a pyramid shape, or a spherical segment shape exists on the surface where the light emitting element 15 is installed.

In a case where the shape of the light emitting element 15 is a pyramid shape, the longitudinal direction of the prism may be parallel to the normal direction (sometimes, referred to as a light guiding direction) of a light incidence surface of the laminate 30, may be perpendicular to the normal direction of the light incidence surface of the laminate 30, or may intersect to be inclined with respect to the normal direction of the incidence surface of the laminate 30.

In addition, in a case where the shape of the light emitting element 15 is a circular line as seen from the upper side in the normal direction of the first surface of the core layer 11, a plurality of the light emitting elements 15 may be arranged in a concentric shape.

In a case where the light emitting element 15 is a concave portion penetrating the first cladding layer 121 and reaching an inner portion of the core layer 11, the concave portion is inclined with respect to the light incidence surface of the laminate 30, and the inclination angle of the concave portion is preferably set as disclosed in WO 2010/073726 A.

The size of the light emitting element 15 is appropriately selected according to the materials of the core layer 11, the first cladding layer 121, the second cladding layer 122, and the light reflecting layer 14.

The depth D of the light emitting element 15 is preferably a depth of the light emitting element which penetrates the first cladding layer 121, reaches an inner portion of the core layer 11, and does not penetrate the core layer 11. Namely, the depth D of the light emitting element 15 preferably satisfies d1<D<d1+d11 with respect to the thickness d1 of the first cladding layer 121 and the thickness d11 of the core layer 11. If the size of the light emitting element 15 is in the aforementioned range, a sufficient amount of the light propagating through the inner portion of the core layer 11 can be extracted from the core layer 11. In addition, the depth D of the light emitting element 15 is defined as a distance from the light emitting surface 17 to the deepest portion of the light emitting element 15.

The depth D of the light emitting element 15 is preferably in a range of 0.1 to 1000 μm, more preferably in a range of 0.5 to 500 μm.

The width W of the light emitting element 15 may be appropriately selected according to the materials of the core layer 11, the first cladding layer 121, the second cladding layer 122, and the light reflecting layer 14. In addition, the width W of the light emitting element 15 is defined as a maximum with of the light emitting element 15 in the normal direction of the light incidence surface of the laminate 30. The depth D and the width W of the light emitting element 15 can be calculated by photographing the laminate 30 where the light emitting element 15 is installed with a microscope, measuring the depth D and the width W at arbitrarily-selected five positions, and obtaining average values thereof.

The width W of the light emitting element 15 is preferably in a range of 1 to 10000 μm, more preferably in a range of 5 to 5000 μm.

FIG. 5 is a schematic perspective diagram illustrating an embodiment of a laminate 40 (hereinafter, simply referred to as a laminate 40 according to the invention) as a form of the invention. The laminate 40 illustrated in FIG. 5 includes a core layer 11, a first cladding layer 121 installed on a first surface of the core layer 11, a second cladding layer 122 installed on a second surface of the core layer 11, a light reflecting layer 14 installed on a second surface of the second cladding layer 122 through an adhesive layer 13, and a plurality of light emitting elements 15 installed in the first surface of the first cladding layer 121 to reach to an inner portion of the core layer 11.

In a case where a plurality of the light emitting elements 15 are installed, the sizes of the light emitting elements 15 such as the depths D of the light emitting elements 15 or the widths W of the light emitting elements 15 may be different among the light emitting elements 15 and may be appropriately selected according to the materials of the core layer 11, the first cladding layer 121, the second cladding layer 122, and the light reflecting layer 14 and the purpose of the laminate 40.

For example, in order to obtain the light source device 60 having uniform luminance irrespective of the distance from the light incidence surface 16, the light emitting element 15 is preferably installed so that the depth D of the light emitting element 15 is increased in proportion to a distance separated from the light incidence surface 16. Namely, as illustrated in FIG. 5, with respect to the depths D1 to D4 of the light emitting elements 15, D1<D2<D3<D4 is preferably satisfied.

In a case where a plurality of the light emitting element 15 are installed, the intervals L1, L2, and L3 among the light emitting elements 15 may be different and can be appropriately selected according to the materials of the core layer 11, the first cladding layer 121, the second cladding layer 122, and the light reflecting layer 14 and the purpose of the laminate 40. The interval L1, L2, or L3 among the light emitting elements 15 denotes a horizontal distance between the deepest portions of the adjacent light emitting elements 15.

For example, in order to obtain the light source device 60 having uniform luminance, the light emitting element 15 is preferably installed so that the intervals L1, L2, and L3 among the light emitting elements 15 are decreased in proportion to a distance separated from the light incidence surface 16. Namely, as illustrated in FIG. 5, with respect to the intervals L1 to L3 among the light emitting elements 15, L1>L2>L3 is preferably satisfied.

The interval L between the light emitting elements 15 is defined as the shortest distance between the deepest portion of the light emitting element 15 and the deepest portion of the adjacent light emitting element 15. The interval L between the light emitting elements 15 can be calculated by photographing the laminate 40 where the light emitting elements 15 are installed with a microscope, measuring the interval L at arbitrarily-selected five positions, and obtaining an average value thereof.

The interval L between the light emitting elements 15 is preferably in a range of 1 to 10000 μm, more preferably in a range of 5 to 5000 μm.

The laminate 10, 20, 30, or 40 according to the invention may include a protective film installed on the front surface if necessary. In addition, the light reflecting layer 14 can also function as a protective film.

A general light guide body needs to include a protective film installed on the front surface thereof in order to prevent scratches during the process or during the transportation. Since the light reflecting layer 14 is installed to have a function of a protective film such as scratch protection, the laminate 10, 20, 30, or 40 including the light reflecting layer 14 needs not include a separate protective film installed on the surface thereof and is preferred.

(Method for Producing Laminate 10, 20, 30, or 40)

The laminate 10 according to the invention can be obtained by laminating the first cladding layer 121 on the first surface of the core layer 11, laminating the second cladding layer 122 on the second surface of the core layer 11, and laminating the light reflecting layer 14 on the second surface of the second cladding layer 122 through the adhesive layer 13. The laminating of the light reflecting layer 14 on the second cladding layer 122 through the adhesive layer 13 denotes that the adhesive layer 13 exists between the second cladding layer 122 and the light reflecting layer 14.

The process of laminating the first cladding layer 121 on the first surface of the core layer 11 and the process of laminating the second cladding layer 122 on the second surface of the core layer 11 may be simultaneously performed or may be separately performed, and in addition, any one of the processes may be formed first.

According to the method for producing the laminate according to the invention, it is possible to manufacture a laminate having a light reflecting layer of which reflectance is easily adjusted and which has excellent durability simply at suppressed production cost.

As a method of laminating the second cladding layer 122, the core layer 11, and the first cladding layer 121, for example, a method of integrally molding the second cladding layer 122, the core layer 11, and the first cladding layer 121 through multilayer melt extrusion, a method of coating the first surface and the second surface of the core layer 11 with the first cladding layer 121 and the second cladding layer 122, a method of a printing process, and the like can be exemplified.

As the method of the coating process, for example, a die coating method, a gravure coating method, a spin coating method, a dip coating method, a bar coating method, a spray coating method, a printing method, and the like can be exemplified.

As the method of the printing process, for example, a screen printing method, an inkjet printing method, and the like can be exemplified.

As a method of installing the adhesive layer 13 on the second surface of the second cladding layer 122, for example, a method of coating the second surface of the second cladding layer 122 with the adhesive layer 13, a method of directly laminating the adhesive layer 13 on the front surface of the second cladding layer 122, and the like can be exemplified.

As the method of the coating process, the above-described methods can be exemplified.

As a method of installing the light reflecting layer 14 on the front surface of the adhesive layer 13, for example, a method of coating the front surface of the adhesive layer 13 with the light reflecting layer 14, a method of directly laminating the light reflecting layer 14 on the front surface of the adhesive layer 13, and the like can be exemplified.

As the method of the coating process, the above-described methods can be exemplified.

Among these methods of installing the light reflecting layer 14 on the front surface of the second cladding layer 122 through the adhesive layer 13, due to simplicity and capability of suppressing the production cost, a method of laminating the light reflecting layer 14 having the adhesive layer 13 on a single side thereof on the front surface of the second cladding layer 122 is preferred.

To laminate denotes to attach.

The laminate 20, 30, or 40 according to the invention can be obtained by further installing the light emitting element 15.

As a method of installing the light reflecting element 15 in the laminate 20, 30, or 40, for example, laser processing, sandpaper processing, press processing, heat press processing, and the like can be exemplified.

In a case where the light emitting element 15 is further installed so as to reach from the surface where the light reflecting layer 14 is installed to an inner portion of the core layer 11, the adhesive layer 13 and the light reflecting layer 14 may be installed after the installation of the light emitting element 15, or the light emitting element 15 may be installed after the installation of the adhesive layer 13 and the light reflecting layer 14. Among the procedures of installing the light emitting element 15, since a large depth D of the light emitting element 15 penetrating the adhesive layer 13 and the light reflecting layer 14 is not needed and stable processing can be performed, the procedure of installing the adhesive layer 13 and the light reflecting layer 14 after the installation of the light emitting element 15 is preferred.

The laminate 20, 30, or 40 is cut in a desired size according to the purpose by using a well-known method. In addition, after the first cladding layer 121 and the second cladding layer 122 are installed on the first surface and the second surface of the core layer 11, the laminate may be cut, and the adhesive layer 13 and the light reflecting layer 14 may be sequentially installed on the front surface of the second cladding layer 122.

The design layer or light diffusion layer 18 may be installed on the light emitting surface 17 of the laminate 20, 30, or 40.

In a case where only one surface of the light source device 60 is desired to emit light, the design layer or light diffusion layer 18 is preferably installed on the light emitting surface 17 of the laminate 20, 30, or 40.

In a case where both surfaces of the light source device 60 is desired to emit light, the design layers or light diffusion layers 18 are preferably installed on both surfaces of the laminate 20, 30, or 40.

The design layer is a layer having a purpose of allowing a design such as a picture or a character to emit light, and for example, a film where design printing is performed on a film having a light transmitting property by using a well-known method, and the like can be exemplified.

The light diffusion layer is a layer having a purpose of diffusing light so as for the light emitting element 15 during the light emission not to be directly visually-recognized, and for example, a well-known light diffusion film and the like can be exemplified.

The design layer or light diffusion layer 18 may cover a portion of the surface of the laminate 20, 30, or 40 or may cover the entire surface thereof.

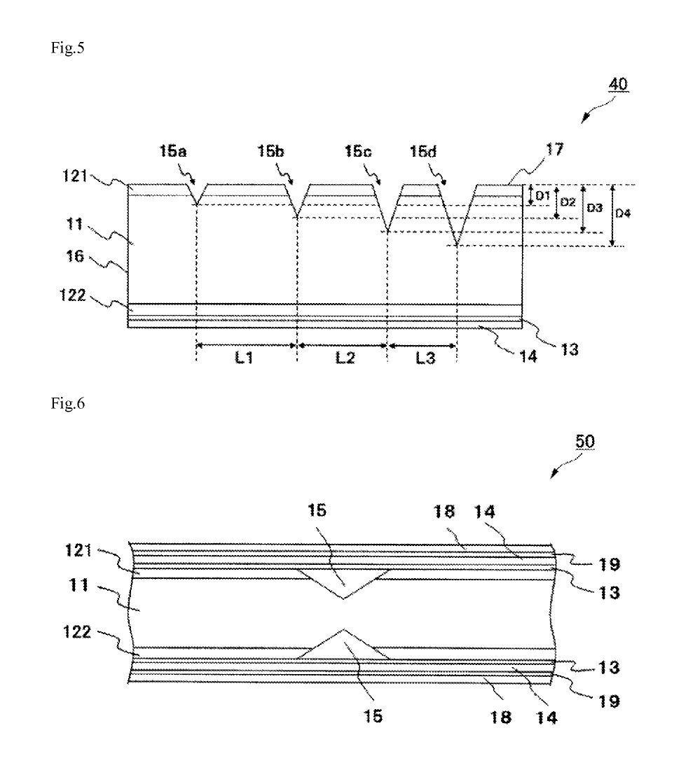

FIG. 6 is a schematic perspective diagram illustrating an embodiment of a laminate 50 (hereinafter, simply referred to as a laminate 50 according to the invention) as a form of the invention. The laminate 50 illustrated in FIG. 6 includes a core layer 11, a first cladding layer 121 installed on a first surface of the core layer 11, a second cladding layer 122 installed on a second surface of the core layer 11, a light emitting element 15 which is a concave portion installed to reach from the first surface of the first cladding layer 121 and the second surface of the second cladding layer 122 to an inner portion of the core layer 11, and light reflecting layers 14 installed on the first surface of the first cladding layer 121 and the second surface of the second cladding layer 122 through adhesive layers 13. In addition, the laminate further includes design layer or light diffusion layers 18 installed through adhesive layers 19 on surfaces of the light reflecting layers 14 of the two surfaces, facing interfaces to the light reflecting layer 14 and the adhesive layer 13.

As a method of installing the design layer or light diffusion layer 18, for example, a method of coating the front surface of the laminate 50 with the design layer or light diffusion layer 18, a method of printing the design layer or light diffusion layer 18 on the front surface of the laminate 50, a method of directly laminating the design layer or light diffusion layer 18 on the front surface of the adhesive layer 19, and the like can be exemplified.

A design layer or light diffusion layer may be further installed on the design layer or light diffusion layer 18. In this case, preferably, the design layer is installed on the light diffusion layer.

As the method of the coating process, the above-described methods can be exemplified.

As the method of the printing process, the above-described methods can be exemplified.

(Light Guide Body for Light Source Device 10, 20, 30, 40, 50)

Laminates 10, 20, 30, 40, and 50 (hereinafter, referred to as 10 to 50) according to the invention can be used as light guide bodies for light source device 10, 20, 30, 40, and 50 (hereinafter, referred to as 10 to 50).

As the light guide bodies for light source device 10 to 50, due to capability of controlling luminance of a light source device 60, preferably, the laminates 20, 30, 40, and 50 according to the invention having the light emitting element 15 can be used.

(Light Source Device 60)

By using the laminate according to the invention as the light guide body for light source device, the light source device 60 can be obtained.

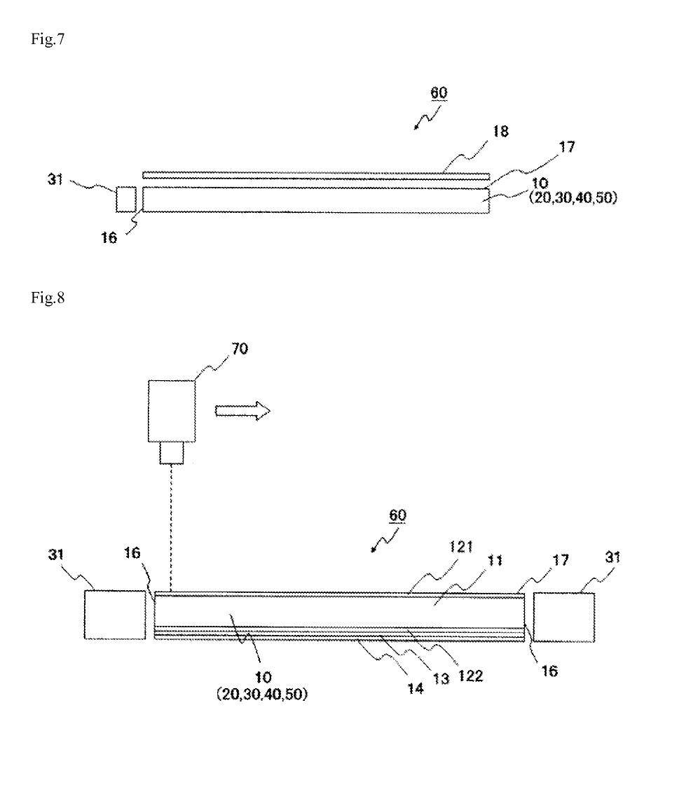

FIG. 7 is a schematic cross-sectional diagram illustrating an embodiment of the light source device 60 using the laminates 10 to 50 according to the invention. In the light source device 60 illustrated in FIG. 7, the laminates 10 to 50 according to the invention are used as the light guide bodies for light source device 10 to 50. In addition, the light source 31 is installed at the light incidence surface 16 side, and the design layer or light diffusion layer 18 is installed at the light emitting surface 17 side.

As the light source 31, for example, a light source where a plurality of well-known point light sources such as LEDs are arranged, a well-known line-shaped light source, and the like can be exemplified. In the case of using the light source where a plurality of the point light sources such as LEDs are arranged, preferably, the light sources are arranged so that the direction of the maximum intensity of light is adjusted.

The light source device 60 may include the design layer or light diffusion layer 18 on the light emitting surface 17.

The design layer or light diffusion layer 18 may be separated from the light guide body for light source devices 10 to 50 and may be in contact with the light guide body for light source device through the adhesive layer 19. Due to the capability of thinning the light source device 60 and the suppression of production cost, preferably, the design layer or light diffusion layer is in contact with the adhesive layer 19 or the like.

As the adhesive layer 19, the above-described adhesive layer 13 can be used.

Since the light source device 60 includes the light reflecting layer 14 in the light guide body for light source devices 10 to 50, the light source device needs not include a separate light reflecting layer. Therefore, the number of parts required for assembling the light source device 60 is decreased, the light source device 60 can be thinned, the process of assembling the light source device 60 can be simplified, and the production cost can be suppressed.

The light source device 60 can very appropriately used, for example, as a light source device of a liquid crystal display device used for a mobile phone, a notebook PC, an LCD TV, a video camera, or the like, a light source device of a display device such as backlight keys of a mobile phone, a backlight keyboard of a PC, or a display switch of an electronic apparatus or a car, or a light source device of an illumination device or the like of indoor lighting such as a ceiling light or an illumination signboard.

### EXAMPLE

Hereinafter, the invention will be described specifically with reference to examples, but the invention is not limited to the examples.

(Measurement of Reflectance of Light Reflecting Layer 14)

With respect to the light reflecting layer 14 used in Example where the adhesive layer 13 was installed on one surface thereof, a reflectance of light of 560 nm from the surface where the adhesive layer 13 was installed was measured by using a spectrophotometer (model name: “CM-508d” produced by Konica Minolta, Inc.). The obtained reflectance was defined as the reflectance of the light reflecting layer 14.

(Measurement of Reflectance of Laminate 10)

With respect to the laminate 10 obtained in Example before the installation of the light emitting element 15, a reflectance of light of 560 nm was measured from the surface of the laminate 10 where the light reflecting layer 14 was not formed by using a spectrophotometer (model name: “CM-508d” produced by Konica Minolta, Inc.). The obtained reflectance was defined as the reflectance of the laminate 10.

(Measurement of Size of Light Emitting Element)

With respect to the light emitting element 15 of the laminate obtained in Example, a depth D and a width W were measured at arbitrarily-selected three positions by using a laser confocal microscope (model name: “LEXT OLS-3000” produced by Olympus Corporation), and the average values thereof were defined as the depth D and the width W of the light emitting element 15, respectively.

(Measurement of Average Normal-Line Luminance)

With respect to the light source device 60 obtained in Example, an average normal-line luminance was measured by using such a measurement apparatus illustrated in FIG. 8.

With respect to the light source devices 60 obtained in Examples 1 to 3, the average normal-line luminance was measured as follows.

Each of LEDs arranged at two ends as the light sources 31 was allowed to emit light at 67 mA, and by using a luminance meter 70 (model name: “BM-7A” produced by Topcon Technohouse Corporation), with respect to an area from a position of 10 mm to a position of 210 mm above the light incidence surface 16, luminance values in the normal direction at 21 points with an increment of 10 mm were measured from a height of 500 mm above the light emitting surface 17, and an average value thereof was set as average normal-line luminance. In addition, a viewing angle in the luminance measurement was set to 2°.

With respect to the light source devices 60 obtained in Examples 4 and 5, the average normal-line luminance was measured as follows.

An LED arranged at one end as the light source 31 was allowed to emit at 67 mA, and by using a luminance meter 70 (model name: “BM-7A” produced by Topcon Technohouse Corporation), with respect to an area from a position of 20 mm to a position of 280 mm above the light incidence surface 16, luminance values in the normal direction at 27 points with an increment of 10 mm were measured from a height of 500 mm above the light emitting surface 17, and an average value thereof was set as an average normal-line luminance.

In addition, a viewing angle in the luminance measurement was set to 2°.

(Measurement of Luminance Distribution)

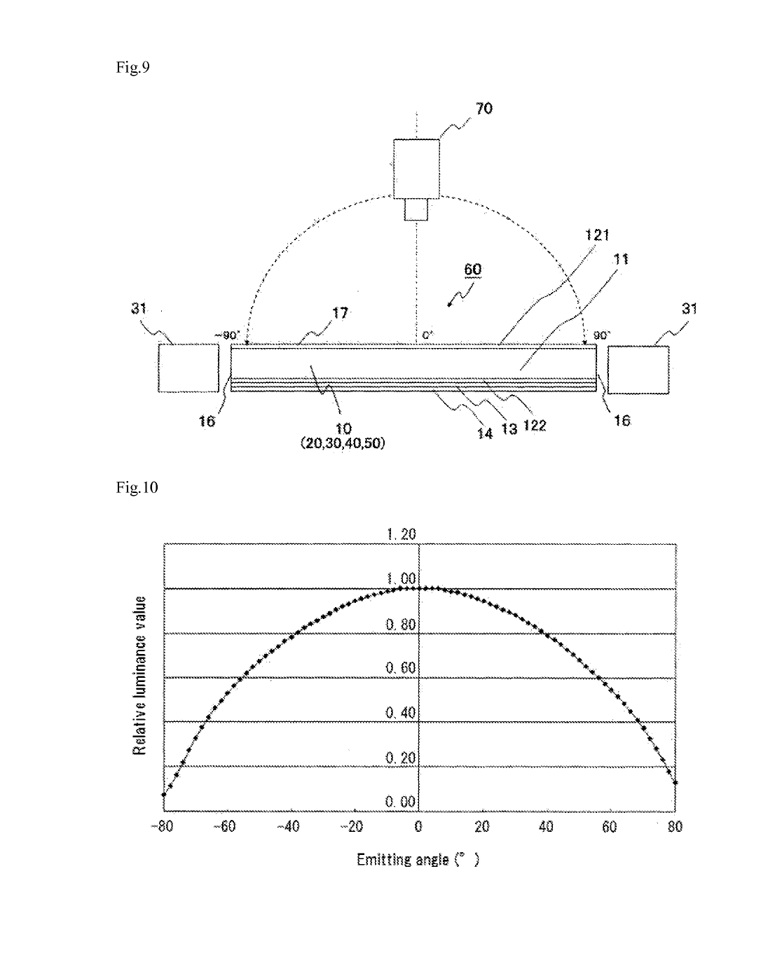

With respect to the light source device 60 obtained in Example, a luminance distribution was measured by using such a measurement apparatus illustrated in FIG. 9.

Each of LEDs arranged as the light sources 31 was allowed to emit light at 67 mA, and by using a luminance meter 70 (model name: “BM-7A” produced by Topcon Technohouse Corporation), with respect to the light emitting from the light emitting surface 17 in an area of 8 millimeter square of which center was the central position of the light guide body for light source device, a luminance distribution at an emitting angle of −80° to 80° of a plane which was parallel to the light guiding direction and perpendicular to the light emitting surface was measured at a height of 500 mm above the light emitting surface 17.

In addition, with respect to the light emission direction, the normal direction of the light emitting surface 17 was set to 0°, one light incidence surface 16 was set to − (minus), the opposite light incidence surface 16 was set to + (plus), and the luminance value at each emitting angle was set as a relative luminance value which was standardized as a peak value of luminance was set to 1.

(Charpy Impact Strength)

With respect to the laminate 10 obtained in Example before the installation of the light emitting element 15, in accordance with ISO 179, a surface of the laminate 10 where the reflecting layer 14 was formed was impacted by a weight of 20 kgf, and Charpy impact strength was measured.

### Example 1

A laminate 10 having a thickness of the first cladding layer 121 of 20 μm, a thickness of the second cladding layer 122 of 20 μm, and a total thickness or 0.7 mm was obtained through multilayer melt extrusion by using a polycarbonate resin (product name: “TARFLON LC2200” produced by Idemitsu Kosan Co., Ltd., refractive index n₁=1.585) as the material of the core layer 11 and using an acrylic resin (product name: “ACRYPET VH000” produced by Mitsubishi Rayon Co., Ltd., refractive index n₂=1.49) as the materials of the first cladding layer 121 and the second cladding layer 122. Among the surfaces of the light reflecting layer 14 (product name: “B310W”, produced by Sun A. Kaken Co., Ltd., polyethylene terephthalate, white film) where the adhesive layer 13 is installed on one surface, the surface close to the adhesive layer 13 was laminated on the surface of the second cladding layer 122. The thickness of the light reflecting layer 14 was 65 μm, and the thickness of the adhesive layer was 4 μm. The reflectance of the laminate 10 was measured.

The obtained laminate 10 was cut in a rectangle shape having a width of 50 mm and a length of 420 mm, and machining was performed by using a diamond bit so that four side surfaces became mirror planes. Next, by performing a laser illumination process on the first surface of the first cladding layer 121, that is, the surface which was to be the light emitting surface 17 by using a CO₂ laser processing machine (model name: “PLS6.120D” produced by Universal Laser Systems, Inc.), the light emitting element 15 which was a substantially conical concave portion was formed, so that the laminate 40 was obtained. In addition, the pattern of laser illumination was set so that the interval L between the light emitting elements 15 was within a range of 0.4 to 1.2 mm and the interval L between the light emitting elements 15 was decreased in proportion to a distance separated from the light incidence surface 16. In addition, with respect to all the light emitting elements 15, the depth D was set to 60 μm, and the width (diameter) was set to 166 μm.

By using the obtained laminate 40 as a light guide body for light source device, setting two facing side surfaces of the light guide body for light source device as the light incidence surfaces 16 and arranging five LEDs (white chip LEDs, product name: “NSSW157T”, produced by Nichia Corporation) as the light sources 31 so that the distance between the centers of the LEDs in the each of the light incidence surfaces 16 was 10 mm so as to face the light incidence surfaces 16 which were the two facing side surfaces of the light guide body for light source device, and thus, the light source device 60 was obtained.

The average normal-line luminance of the obtained light source device 60 is listed in Table 1, and the luminance distribution of the obtained light source device 60 is illustrated in FIG. 10.

### Example 2

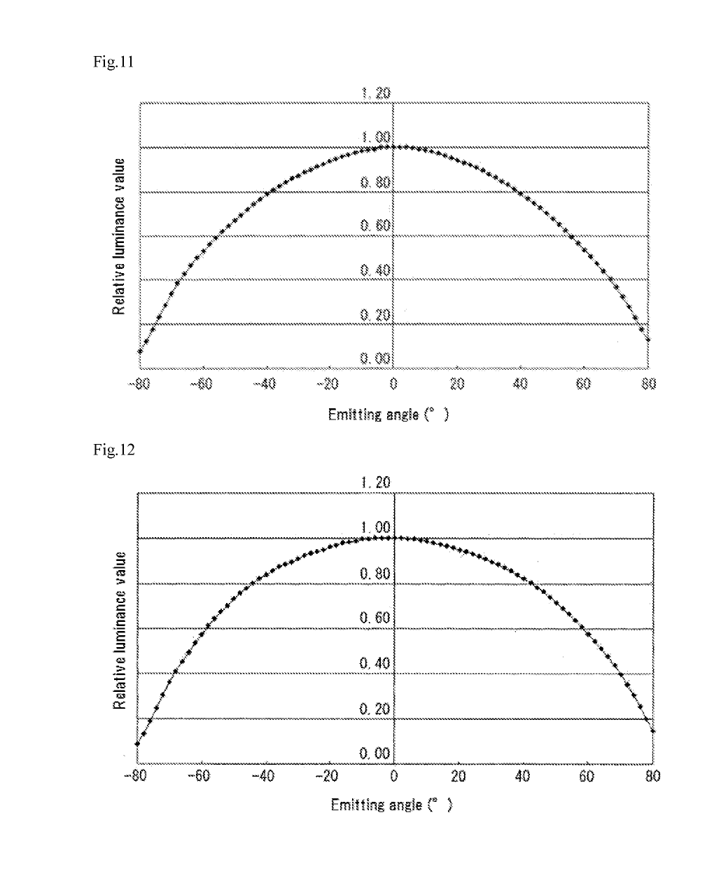

Except that the light reflecting layer 14 where the adhesive layer 13 was installed on one surface was replaced with “E-241WS” (product name, produced by Sumilon Industries Ltd., polyethylene terephthalate, white film), the same processes as those of Example 1 were performed, and thus, the light source device 60 was obtained. The thickness of the light reflecting layer 14, the reflectance of the light reflecting layer 14, the reflectance of the laminate 10, and the average normal-line luminance of the obtained light source device 60 are listed in Table 1, and the luminance distribution of the obtained light source device 60 is illustrated in FIG. 11. In addition, the thickness of the adhesive layer was 4 μm.

### Example 3

Except that the light reflecting layer 14 where the adhesive layer 13 was installed on one surface was replaced with “MTN-W400” (product name, produced by TSUJIDEN Co., Ltd., polyethylene terephthalate, white film), the same processes as those of Example 1 were performed, and thus, the light source device 60 was obtained. The thickness of the light reflecting layer, the reflectance of the light reflecting layer 14, the reflectance of the laminate 10, and the average normal-line luminance of the obtained light source device 60 are listed in Table 1, and the luminance distribution of the obtained light source device 60 is illustrated in FIG. 12. In addition, the thickness of the adhesive layer was 4 μm.

### Comparative Example 1

Except that screen printing was performed one time by using white screen printing ink (product name: “#2500 120 White” produced by Seiko Advance Ltd., acrylic resin) instead of laminating the light reflecting layer 14 where the adhesive layer 13 was installed on one surface, the same processes as those of Example 1 were performed, and thus, the light source device 60 was obtained. The thickness of the light reflecting layer, the reflectance of the laminate 10, and the average normal-line luminance of the obtained light source device 60 are listed in Table 1.

### Comparative Example 2

Except that the screen printing was performed three times, the same processes as those of Comparative Example 1 were performed, and thus, the light source device 60 was obtained. The thickness of the light reflecting layer, the reflectance of the laminate 10, and the average normal-line luminance of the obtained light source device 60 are listed in Table 1.

TABLE 1

| | Thickness of Light | Reflectance of Light | Reflectance of | Average Normal- | Charpy Impact |
|---|---|---|---|---|---|
| | Reflecting Layer | Reflecting Layer | Laminate | Line Luminance | Strength |
| | (μm) | (%) | (%) | (cd/m²) | (kJ/m²) |
| Example 1 | 65 | 76 | 70 | 640 | 29.3 |
| Example 2 | 83 | 81 | 75 | 663 | 34.2 |
| Example 3 | 256 | 96 | 85 | 749 | 42.2 |
| Comparative | 10 | — | 62 | 526 | 27.5 |
| Example 1 | | | | | |
| Comparative | 29 | — | 68 | 620 | 27.8 |
| Example 2 | | | | | |

### Example 4

A laminate having a thickness of the first cladding layer 121 of 20 μm, a thickness of the second cladding layer 122 of 20 μm, and a total thickness of 0.7 mm was obtained through multilayer melt extrusion by using a polycarbonate resin (product name: “TARFLON LC2200” produced by Idemitsu Kosan Co., Ltd., refractive index n₁=1.585) as the material of the core layer 11 and using an acrylic resin (product name: “ACRYPET VH000” produced by Mitsubishi Rayon Co., Ltd., refractive index n₂=1.49) as the materials of the first cladding layer 121 and the second cladding layer 122.

The obtained laminate 10 was cut in a rectangle shape having a width of 50 mm and a length of 300 mm, and machining was performed by using a diamond bit so that four side surfaces became mirror planes. Next, by performing a laser illumination process on the on the surface of the first cladding layer 121 and the surface of the second cladding layer 122 of the obtained laminate 10 by using a CO₂ laser processing machine (model name: “PLS6.120D” produced by Universal Laser Systems, Inc.), the light emitting element 15 which was a substantially conical concave portion was formed, the laminate 40 was obtained. In addition, the pattern of laser illumination was set so that the interval L between the light emitting elements 15 was within a range of 0.4 to 1.2 mm and the interval L between the light emitting elements 15 was decreased in proportion to a distance separated from the light incidence surface 16. In addition, with respect to the light emitting elements 15, the depth D was set to 60 μm, and the width (diameter) was set to 166 μm.

Among the surfaces of the light reflecting layer 14 (product name: “FM-715W” produced by Daiyo Kakousi Industry Ltd., white film) where the adhesive layer 13 was installed on one surface, the surface having the adhesive layer 13 was laminated on the first surface of the first cladding layer 121 and the second surface of the second cladding layer 122 of the obtained laminate. The thickness of the light reflecting layer 14 was 70 μm, and the thickness of the adhesive layer was 4 μm.

By using the obtained laminate as a light guide body for light source device, setting one of two facing side surfaces of the light guide body for light source device as the light incidence surface 16 and arranging five LEDs (product name: “NSSW157T” produced by Nichia Corporation) as the light sources 31 so that the distance between the centers of the LEDs was 10 mm so as to face the light incidence surface 16, and thus, the doubles-sided light-emitting light source device 60 was obtained. The average normal-line luminance of the obtained light source device 60 is listed in Table 2. In addition, in Table 2, the front surface denotes the surface facing the interface between the light reflecting layer 14 and the adhesive layer 13 among the surfaces of the light reflecting layer 14 laminated on the first cladding layer 121. In addition, in Table 2, the rear surface denotes the surface facing the interface between the light reflecting layer 14 and the adhesive layer 13 among the surfaces of the light reflecting layer 14 laminated on the second cladding layer 122.

### Example 5

Except that the interval L between the light emitting elements 15 was set to be within a range of 0.2 to 1.0 mm and the interval L between the light emitting elements 15 was set to be decreased in proportion to a distance separated from the light incidence surface 16, same processes as those of Example 4 were performed, and thus, the light source device 60 was obtained. The reflectance of the light reflecting layer 14 and the average normal-line luminance of the obtained light source device 60 are listed in Table 2.

TABLE 2

| | | Reflectance of Light | Average Normal- |
|---|---|---|---|
| | | Reflecting Layer | Line Luminance |
| | Measuring Surface | (%) | (cd/m²) |
| Example 4 | Front Surface | 55 | 474 |
| | Rear Surface | 55 | 487 |
| Example 5 | Front Surface | 55 | 668 |
| | Rear Surface | 55 | 719 |

As can be understood from Tables 1 and 2, by using the laminate according to the invention as a light guide body for light source device in the light source device, it is possible to obtain the light source device with simple processes.

In addition, it can be understood that the obtained light source device has excellent luminance and the luminance of the light source device can be controlled according to the reflectance of the light reflecting layer 14.

### INDUSTRIAL APPLICABILITY

In a laminate according to the invention, a reflectance of a light reflecting layer is easily adjusted, and durability is excellent. In addition, by using a laminate according to the invention, it is possible to obtain a light source device having excellent luminance. The obtained light source device can be very appropriately used, for example, as a light source device of a liquid crystal display device used for a mobile phone, a notebook PC, an LCD TV, a video camera, or the like, a light source device of a display device such as backlight keys of a mobile phone, a backlight keyboard of a PC, or a display switch of an electronic apparatus or a car, or a light source device of an illumination device or the like of indoor lighting such as a ceiling light or an illumination signboard.

### EXPLANATIONS OF LETTERS OR NUMERALS

10, 20, 30, 40, 50: laminate
11: core layer
121: first cladding layer
122: second cladding layer
13: adhesive layer
14: light reflecting layer
15: light emitting element
15a: light emitting element
15b: light emitting element
15c: light emitting element
15d: light emitting element
16: light incidence surface
17: light emitting surface
18: design layer or light diffusion layer
19: adhesive layer
10, 20, 30, 40, 50: light guide body for light source device
60: light source device
31: light source
70: luminance meter

1. A laminate comprising:
a core layer;
a first cladding layer;
a second cladding layer; and
a light reflecting layer,
wherein the light reflecting layer, the second cladding layer, the core layer, and the first cladding layer are sequentially laminated,
wherein a refractive index of the first cladding layer and a refractive index of the second cladding layer are lower than a refractive index of the core layer, and
wherein a thickness of the light reflecting layer is 50 μm or more.

2. The laminate according to claim 1, further comprising a light emitting element.

3. The laminate according to claim 1, further comprising an adhesive layer between the light reflecting layer and the second cladding layer.

4. The laminate according to claim 1, wherein the light reflecting layer is made of a material which scatters and reflects light.

5. The laminate according to claim 1, wherein a material of the light reflecting layer is a material of at least one type selected from a group including a polyolefin resin, a polyester resin, an acrylic resin, and cellulose.

6. The laminate according to claim 1, wherein a reflectance of the light reflecting layer is 70% or more.

7. The laminate according to claim 1, wherein a reflectance of the light reflecting layer is 65% or less.

8. The laminate according to claim 7, wherein in the light reflecting layer, a layer of at least one type selected from a group including a design layer and a light diffusion layer is further laminated on a surface facing an interface between the light reflecting layer and the second cladding layer.

9. A method for producing a laminate, comprising:
laminating a first cladding layer on a first surface of a core layer;
laminating a second cladding layer on a second surface of the core layer; and
laminating a light reflecting layer on a second surface of the second cladding layer,
wherein a refractive index of the first cladding layer and a refractive index of the second cladding layer are lower than a refractive index of the core layer,
wherein a thickness of the light reflecting layer is 50 μm or more, and
wherein laminating of the light reflecting layer is performed by lamination.

10. A light guide body for light source device comprising the laminate according to claim 1.

11. A light source device comprising the laminate according to claim 1 and a light source.

12. A single-sided light-emitting light source device comprising the laminate according to claim 6 and a light source.

13. A double-sided light-emitting light source device comprising the laminate according to claim 7 and a light source.
